(19) United States
(12) Patent Application Publication
(10) Pub. No.: US 2024/0100560 A1
(43) Pub. Date: Mar. 28, 2024

(54) A DISPENSER AND A CONTROL METHOD OF THE DISPENSER

(71) Applicant: HILTI AKTIENGESELLSCHAFT, Schaan (LI)

(72) Inventors: Rocco STOLT, Niederraunau (DE); Michael Wiedemann, Koenigsbrunn (DE)

(73) Assignee: HILTI AKTIENGESELLSCHAFT, Schaan (LI)

(21) Appl. No.: 18/256,408

(22) PCT Filed: Nov. 16, 2021
(86) PCT No.: PCT/EP2021/081812

§ 371 Date: Jun. 7, 2023

(30) Foreign Application Priority Data
Dec. 10, 2020 (EP) 20212987.0

(51) Int. Cl. B05C 17/01; B05C 17/005

(52) U.S. Cl. CPC B05C 17/0103; B05C 17/0052; B05C 17/00583

(57) ABSTRACT

A dispenser for compound-containing containers includes a cassette for a container; at least one push rod displaceable relative to the cassette; a motor for moving the at least one push rod; a main switch for generating a control signal in response to actuation of the main switch; a control unit for controlling the motor; and a sensor configured to detect the moving of the push rod which is electronically connected to the control unit. The control unit is configured to store the dispensed volume of the compound and provide a feedback to the user once the dispensed volume of the compound reaches a defined value, and the user gets informed as soon as the cassette should be checked. Based on saved information of the dispensed volume of the compound, the user can be informed if a specified volume is reached and a check of the cassette is recommended.

### TECHNICAL FIELD

The present invention relates to a dispenser for compound-containing containers. The present invention also relates to a control method for use in such a dispenser.

A dispenser is used for dispensing compounds which are packaged in containers, such as mortar and sealing compounds, at a site of application. The containers include, for example, hard cartridges having one or more receiving chambers for one or more components of the compound to be dispensed which are provided directly or packaged, e.g. in foil packs, in the receiving chambers of the cartridge. The term “container” further includes foil packs which are filled with one or more compounds to be dispensed and which are inserted in a separate receiving body or in a receiving body mounted on the dispenser, since these foil packs have no side stability relative to their axial direction. The receiving body is so called a cassette or foil pack holder.

As the foil pack needs a cassette as a support while applying dispensing forces to the system. Due to dirt, wear or cured mortar, the cassette should be checked by the user regularly. Typically, the cassette or the foil pack holder should be checked every time before use, to ensure that the it is clean and the pistons move freely in the holder. If the pistons show higher friction in the cassette or the inner surface is contaminated, the cassette has to be replaced.

Currently the user checks the cassette after a certain numbers of dispensed foil packs, to ensure the security and correct function of the cassette. Since there is no counter available, the user can only note or estimate the numbers of dispensed foil packs.

### SUMMARY OF THE INVENTION

It is an object of the present invention to provide a dispenser and an operating method for the dispenser will be able to provide an automated maintenance alert to the user as soon as the cassette shall be checked for wear, dirt or other contamination.

The present invention provides a method for operating a dispenser for compound-containing containers, comprising the following steps: triggering the main switch to activate the motor; a sensor detecting the movements of the push rod; a control unit storing the dispensed volume of the compound and providing a feedback to the user once the dispensed volume of the compound reaches a defined value.

With this preventive maintenance function, the user gets informed as soon as the dispensed volume has reached a defined volume, and then the cassette shall be checked. This is provided by the sensor detecting the position of the push rod and tracing its movements while operation. The control unit calculates a value representing the dispensed volume based on the movements of the push rod detected by the sensor. The defined volume is defined by the user in advanced in consideration of the requirement for maintaining the cassette.

Preferably, the dispensed volume of the compound is a value represented by summarizing the previously movements of the push rod. As the sensor is electronically connected to the control unit, then the sensor sends the data of previously movements of the push rod to the control unit. The control unit comprises a memory module configured to store the dispensed volume of the compound and a data process module configured to calculate if the dispensed volume of the compound reaches the defined value. Thus, the data process module transmits the change of the position of the push rod into the volume of the compound which has been already dispensed. Moreover, the memory module of control unit will store the value of the dispense volume of the compound.

Preferably, the defined value depends on the volume of different containers and the numbers of the dispensed containers as a limit for maintenance. For that automated maintenance alert, the user expects a certain number of dispensed containers as a limit for replacement of the cassette. Since the containers has different volumes, the certain volume of the limit for replacement will be different. This value will be determined based on the volume of the containers times the expected numbers of the dispensed containers where a maintenance of cassette shall be done.

The present invention provides a dispenser for compound-containing containers, comprising: a cassette for a container; at least one push rod displaceable relative to the cassette; a motor for moving the at least one push rod; a main switch for generating a control signal in response to actuation of the main switch; and a control unit for controlling the motor; a sensor configured to detect the moving of the push rod which is electronically connected to the control unit, and the control unit being configured to store the dispensed volume of the compound and provide a feedback to the user once the dispensed volume of the compound reaches to a defined value.

In an advantageous configuration of the dispenser according to the invention it is provided that the control unit comprises a memory module configured to store the dispensed volume of the compound and a data process module configured to calculate if the dispensed volume of the compound reach the defined value. Thus, the data process module transmits the change of the position of the push rod into the volume of the compound which has been already dispensed. Moreover, the memory module of control unit will store the value of the dispense volume of the compound.

In another advantageous configuration of the dispenser according to the invention it is provided that the dispenser comprises an indicator which is electrically connected to the control unit and generates a user-perceivable signal when the dispensed volume of the compound reaches a defined value. This allows the user to fulfil his responsibility to check the cassette or decide if the cassette has to be replaced. Advantageously, the user-perceivable signal is an audible signal and/or a visible signal. Alternatively, the dispenser has a connection to a smart device or a cloud. The connection could be, for example, a Bluetooth, NFC, etc. The smart device installs a software or an application to process the information and generate a signal to inform the user to change the cassette.

In another advantageous configuration of the dispenser according to the invention it is provided that the dispenser comprises a receiver configured to read the information of the container's volume and a data process module configure to determine the defined value based on the information. The receiver of the dispenser will identify the volume of different foil packs, then the control unit will automatically calculate the defined value of the limit for maintenance.

Preferably, the container is a foil pack, as the foil pack needs a cassette as a support while applying dispensing forces to the compound in the container.

### BRIEF DESCRIPTION OF THE DRAWINGS

Further features and advantages of the invention are described in greater detail hereinafter by means of an embodiment by way of example with reference to the drawings. In the Figures:

FIG. 1 is a top, front perspective view of an embodiment of a dispenser;

FIG. 2 is a schematic diagram of the dispenser of FIG. 1 including a control unit.

FIG. 3 illustrates the flow chart of the operating method of the dispenser of FIG. 1.

### DETAILED DESCRIPTION

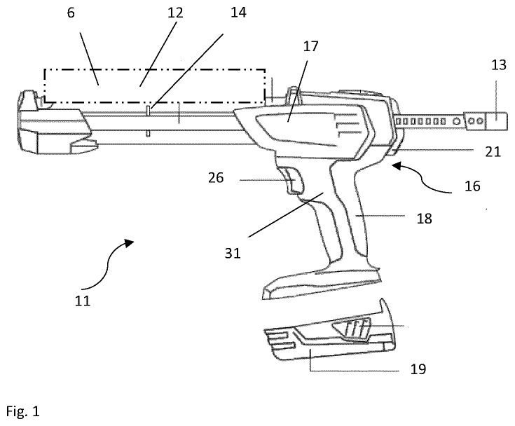

Dispenser 11 for compound-containing containers 6, as shown in FIG. 1, has a receiving chamber 12 for container 6, a push rod 13 which is displaceable relative to receiving chamber 12, and an electrically operable extrusion mechanism. A pressure piston 14 for applying pressure to container 6 and/or to the compound contained therein is provided on the end of push rod 13 facing receiving chamber 12. Operation of dispensing mechanism 16 causes push rod 13 to move into receiving chamber 12, thereby pressurizing the compound contained in container 6, causing it to be extruded through outlet of container 6. The compound contained in container 6 includes one or several components. According to a preferred embodiment of the invention, the compound contained in container 6 includes two compounds, thereby two push rods being displaceable relative to the receiving chamber 12. A mixer (not shown) is advantageously provided at outlet of the container 6, said mixer ensuring complete mixing of the components prior to being discharged through the outlet.

Dispenser 11 for compound-containing containers 6, as shown in FIG. 1, has a cassette 12 for supporting the container 6, a push rod 13 which is displaceable relative to cassette 12, and an electrically operable dispensing mechanism. A pressure piston 14 for applying pressure to container 6 and/or to the compound contained therein is provided on the end of push rod 13 facing the cassette 12. Operation of dispensing mechanism 16 causes push rod 13 to move into the cassette 12, thereby pressurizing the compound contained in container 6, causing it to be extruded through outlet of container 6. The compound contained in container 6 includes one or several components. According to a preferred embodiment of the invention, the compound contained in container 6 includes two compounds, thereby two push rods being displaceable relative to the cassette 12. A mixer (not shown) is advantageously provided at outlet of container 6, said mixer ensuring complete mixing of the components prior to being discharged through the outlet.

Dispensing mechanism 16 is accommodated in a housing 17 having a handle 18 extending therefrom. A power supply 19 in the form of a battery pack is detachably connected to the free end of handle 18. Dispensing mechanism 16 includes a motor 21 which, via a transmission mechanism, drives a drive wheel (not shown) meshing with teeth on push rod 13, thereby moving the push rod 13.

Handle 18 is further provided with a main switch 26 in the form of a push button for generating a control signal in response to actuation of main switch 26. Also provided is a control unit 31 for controlling motor 21, said control unit having a power module for connecting the motor 21 to power supply 19. The main switch 26 is electrically connected to control unit 31.

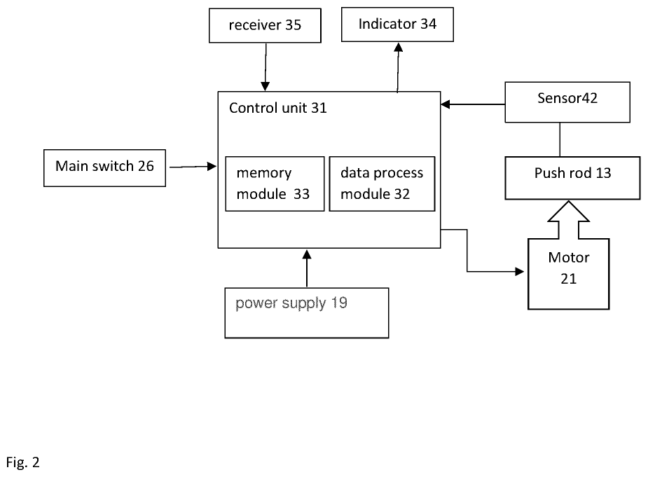

As shown schematically in FIG. 2, the dispenser further comprises a sensor 42 for detecting the movements of the at least one push rod 13. The control unit 31 comprises a data process module 32 and a memory module 33. The sensor 42 is electronically connected to the control unit 31. Said push rod 13 is configured to link to the sensor 42. The sensor 42 detects the movements of the push rod 13, therefore the dispensed amount of the compound is a value represented by summarizing the previously movements of the push rod 13. The sensor 42 sends the signal of the movements of the push rod 13, then the data process module 32 of the control unit will calculate the amount of the compound which has been already dispensed based on the summary of the previous movements of the push rod 13 and store the data in the memory module 33.

Preferably, the container 6 is a foil pack. It is well known that the container includes hard cartridges and foil packs. Hard cartridges do not require a cassette while foil packs need a cassette 12 as support. The cassette 12, should be checked every time before use, to ensure that it is clean, and the pistons 14 move freely in the holder. If the pistons 14 show higher friction in the cassette 12 or the inner surface is contaminated, the cassette 12 has to be replaced.

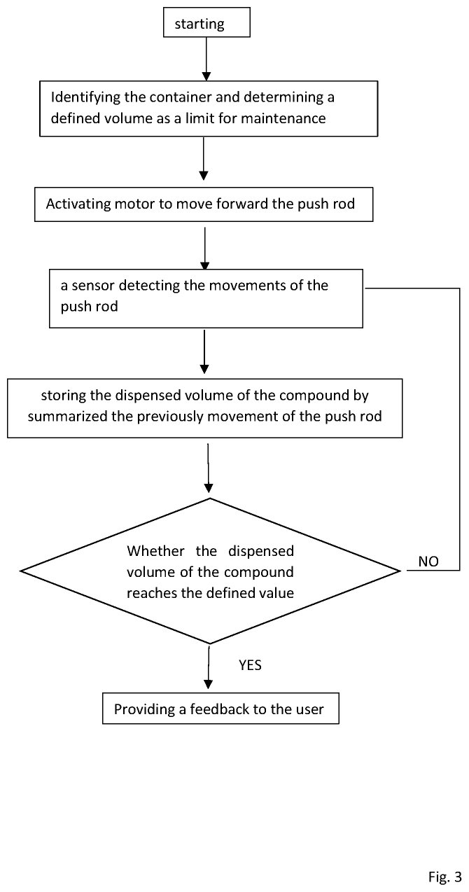

Referring to FIG. 3, according to the invention the method for operating a dispenser for compound-containing containers, comprises the following steps: triggering the main switch to activate the motor; a sensor detecting the movements of the push rod; a control unit storing the dispensed volume of the compound and providing a feedback to the user once the dispensed volume of the compound reaches a defined value.

According to one preferred embodiment of the invention, the dispensed volume of the compound is a value representing the previously movements of the push rod. The defined value depends on the volume of different containers and the numbers of the dispensed containers as a limit for maintenance. For that automated maintenance alert, it is expected that approximate 200 dispensed foil packs/cartridges as a number limit for replacement of the cassette 12. The foil packs in the market have different volumes, such as 330 ml, or 500 ml. The certain volume of the limit for replacement will be different. This defined value will be determined based on the volume of the containers. In an exemplary embodiment, the foil pack's volume is 500 ml, and as the expected number of dispensed foil pack for the maintenance is 200, then the certain volume for the automated maintenance alert would be 100 L. Once the control unit calculates the dispensed volume of the foil packs reaching to 100 l, based on the data of paths of the push rod detected by the sensor 42, the expected number for maintenance alert is reached, then the user will be informed to check the cassette 12 and decide if the cassette shall be replaced or not. The maintenance alert is more a support to remind the user to check and replace the cassette. Maintenance here means to check and replace if required. Cleaning can be an option, but in most cases, it is not possible and will not lead to sufficient results.

Preferably, the dispenser comprises an indicator 34 which is electrically connected to the control unit 31 and generates a user-perceivable signal when the dispensed volume of the compound reaches a defined value. This allows the user to fulfil his responsibility to check the cassette or decide if the cassette has to be replaced. Advantageously, the user-perceivable signal is an audible signal and/or a visual signal. For example, a LED will be lighted up as an indicator of maintenance alert. Alternatively, a smart device (not shown) or a cloud connects to dispenser. The information of dispensed volume could also be stored in the tool electronics. Having a connection to smart devices (e.g. Bluetooth, NFC, etc.) or to a cloud this information could be processed in e.g. Hilti Connect App or other applications to inform the user to change the cassette.

In another preferred embodiment of the invention, the dispenser 11 further comprises a receiver 35 which can read the information of the container's volume and the data process module 33 determines the defined value based on the information. The receiver 35, for example, may be a device which can scan a radio frequency tag or a data matrix code. When the receiver 35 read the RF tag or data matrix code, the data process module 32 transmits the information to a defined value of the limit for maintenance alert.

Using the dispenser according to the present invention is in a convenient manner to remind the use to check the cassette for the containers if there is wear, dirt or other contaminations, to ensure the security and correct function of the cassette.

While only selected embodiments have been chosen to illustrate the present invention, it will be apparent to those skilled in the art from this disclosure that various changes and modifications can be made herein without departing from the scope of the invention as defined in the appended claims. Thus, the foregoing descriptions of the embodiments according to the present invention are provided for illustration only, and not for the purpose of limiting the invention as defined by the appended claims and their equivalents.

1. A method for operating a dispenser for a compound-containing container, the method comprising:
triggering a main switch to activate a motor and a sensor detecting movements of at least one push rod;
with a control unit, storing a dispensed volume of a compound, and
providing a feedback to a user once the dispensed volume of the compound reaches a defined value.

2. The method according to claim 1, wherein the dispensed volume of the compound is a value represented by summarizing the previous movements of the at least one push rod.

3. The method according to claim 1, wherein the defined value depends on a volume of different compound-containing containers and the number of dispensed compound-containing containers as a limit for maintenance.

4. The method according to claim 3, wherein the dispenser comprises a receiver configured to read information about the compound-containing container's volume, wherein the control unit determines the defined value based on the information read by the receiver.

5. A The method according to claim 3, further comprising a smart device or a cloud configured to connect to the control unit, wherein the smart device or the cloud generates a signal to inform the user to change a cassette when the dispensed volume of the compound reaches the defined value.

6. A dispenser for a compound-containing container, comprising:
a cassette for the compound-containing container;
at least one push rod displaceable relative to the cassette;
a motor for moving the at least one push rod;
a main switch for actuating the motor;
a control unit for controlling the motor; and
a sensor configured to detect movements of the at least one push rod, said sensor electronically connected to the control unit, and
wherein the control unit is configured to store a dispensed volume of a compound and provide a feedback to a user once the dispensed volume of the compound reaches a defined value.

7. The dispenser according to claim 6, wherein the dispensed volume of the compound is represented by summarizing the previous movements of the at least one push rod.

8. The dispenser according to claim 7, wherein the control unit comprises a memory module configured to store the dispensed volume of the compound, and a data process module configured to determine whether the dispensed volume has reached the defined value.

9. The dispenser according to claim 8, further comprising an indicator electrically connected to the control unit and which generates a user-perceivable signal when the dispensed volume of the compound reaches the defined value.

10. The dispenser according to claim 9, further comprising a smart device configured to connect to the control unit and generate a signal to inform the user to change the cassette when the dispensed volume of the compound reaches the defined value.

11. The dispenser according to claim 8, further comprising a receivers configured to read information of the compound-containing container's volume, and wherein the data process module is configured to determine the defined value based on the information read by the receiver.

12. The dispenser according to claim 6, wherein the compound-containing container is a foil pack.
